(19) United States
(12) Patent Application Publication
(10) Pub. No.: US 2005/0242971 A1
(43) Pub. Date: Nov. 3, 2005

(54) System and method for safe disablement of mobile pieces of equipment (MPEs)

(76) Inventor: Gregory Dryer, New York, NY (US)

Correspondence Address: MCHALE & SLAVIN, P.A., 2855 PGA BLVD, PALM BEACH GARDENS, FL, 33410, US

(21) Appl. No.: 10/991,963

(22) Filed: Nov. 17, 2004

Related U.S. Application Data
(63) Continuation-in-part of application No. 10/621,235, filed on Jul. 15, 2003.

(51) Int. Cl. G08C 19/04

(52) U.S. Cl. 340/870.11; 340/539.19; 340/426.11; 307/10.3

(57) ABSTRACT

A system for safe disablement of a mobile piece of equipment (MPE) in which an onboard processor (CPU) includes a component control unit (CCU) coupled to a critical operational component of the MPE. The CCU is operable to effect immobilization of the MPE in a first mode of operation and to enable the critical operational component in second more of operation. Using an integral communications interface, the CPU can be accessed by a cellular telephone network, pager signal, RF transmission, or via a satellite network. A software algorithm initiates a Disable Procedure which continuously queries the binary status of the key power circuit at preset intervals to determine if it is on or off. If the status of the key power circuit remains off for a predetermined interval, the critical component is then disabled by actuating the CCU. A disable command can originate remotely using wireless transmission means. The disablement can also be automatic based on calendar and geographic location parameters. Disablement is also effected when system tampering is detected.

### CROSS REFERENCE TO RELATED APPLICATIONS

This is a continuation-in-part of application Ser. No. 10/621,235 filed on Jul. 15, 2003 entitled “WIRELESS SECURITY, TELEMETRY AND CONTROL SYSTEM,” herein incorporated in its entirety by reference.

### FIELD OF THE INVENTION

The present invention relates generally to an improved security and control system for mobile pieces of equipment (MPEs), and more particularly to a system and method for monitoring and safe disablement for MPEs in both remote and automatic implementations.

### BACKGROUND OF THE INVENTION

The theft of motor vehicles and MPEs is a crime with a high cost to society, both in terms of personal loss to the victim (financial and emotional) and the resultant higher rates for insurance paid by the general public. Motor vehicle and MPE theft also adds greatly to the manpower burden on law enforcement agencies as they must try to recover the vehicles and deal with ancillary crimes that may be committed during the theft.

Construction equipment can be particularly vulnerable to mischief and theft because it often left unattended at the site. For construction equipment and other work related vehicles, it would be particular desirable to confine the operation of the vehicles to certain locations and operating times. It would also be advantageous to similarly restrict the operation of rental equipment and rental recreational vehicles. The present invention addresses this problem by providing a means to safely disable MPEs when they travel out of a prescribed area, or if attempts are made to operate the vehicle outside of a designated time frame.

The present invention also provides a way to remotely disable a vehicle using available communications networks and transmissions means such as pager units, cellular telephone systems, RF transmitters, satellite networks, or via an Internet web site. Disabling a MPE can be an invaluable aid for the purposes of asset recovery, security, credit collection, and safety. The remote disabling of a MPE can be an extremely effective method to recover a vehicle, however there is an inherent liability involved because it can create great danger to the operator and innocent members of the public if the vehicle is disabled while in motion.

There are many systems disclosed in the prior art for remotely disabling a vehicle, however these systems do not adequately address the inherent danger of indiscriminately rendering a moving MPE inoperable.

U.S. Pat. No. 5,742,227 issued to Escareno et al. disclosed a vehicle theft prevention and recovery system which is activated by a pager upon receiving a telephonic signal from a pager service, in response to a call from a vehicle owner or operator, to activate anti-theft means including a warning to a thief in the vehicle, means for disabling the vehicle engine, and visual and audible alarm signal devices to identify the vehicle as stolen. In the Escareno et al. system, an audible or visible countdown is given to the driver that disablement is imminent.

Obvious drawbacks include the fact that the driver may not comprehend the meaning of the countdown in time to take action. In U.S. Pat. Nos. 5,926,086 and 6,163,251, Escareno et al. disclose an additional embodiment in which a global positioning system will inform a central station of the location of the vehicle and the central station can initiate operation of the vehicle engine disablement when the vehicle is in a relatively safe location to cause such disablement.

U.S. Pat. No. 5,276,728 issued to Pagliaroli et al. discloses a system for remotely disabling or enabling an automobile in which signal codes are transmitted to a receiver and compared to an enabling code and a disabling code stored within a programmable memory. When the owner of an automobile finds the vehicle stolen, the owner dials the telephone number corresponding to the disabling code of the automobile. The dialed number causes a signal code to be transmitted from the mobile telephone transmitted network, wherein the signal code is received by the stolen automobile. If the transmitted signal code matches the programmed disabling code the automobile is disabled. Pagliaroli et al. do not make any provisions for the safe disablement of the vehicle, and do not address the potential hazards. In one embodiment, the disable codes are only available to police on short range transmitters so that they can visually observe the vehicle and only disable it at opportune times. The present invention is an improvement over the Pagliaroli et al. system in that it provides a method for automatic, safe, remote disablement of a MPE.

U.S. Pat. No. 5,990,785 issued to Suda discloses an apparatus for remotely communicating with the vehicle to control functional circuits in the vehicle. The apparatus includes a pager-based communication apparatus mounted in the vehicle for receiving a command signal from a pager service provider in response to a user generated telephone number, security code and a command. A micro controller is responsive to the received command and, in response to a stored control program, generates outputs to various vehicle functional circuits to deactivate the vehicle engine in the event of a hijack command when the engine RPM drops below a pre-stored engine RPM magnitude. There are obvious drawbacks to this system in that momentary RPM magnitude is not necessarily a good indicator of a safe disabling situation.

U.S. Pat. No. 6,717,511 issued to Parker et al. discloses a system for preventing vehicle theft that can be activated and deactivated from a touch-tone phone. The alarm activation code and alarm deactivation code are capable of activating a plurality of switches through the feedback loop. When the car is stolen, the owner can activate the signal code, which will disable the engine once the thief turns off the engine. The disablement process is accomplished by deactivation of the engine starter. A drawback is of this system is that the relative simplicity of the system may make it easily defeated by a knowledgeable car thief.

Therefore, a need remains for an effective and safe means to disable a MPE which is superior to those described in the prior art. The present invention addresses this need, and further provides an improved means for automatic disablement of a MPE using geographic and calendar-based parameters.

### SUMMARY OF THE INVENTION

Accordingly, it is an objective of the instant invention to provide an improved method for disabling a Mobile Piece of Equipment (MPE), either remotely or automatically, which does not endanger the operator or the public.

It is yet another objective of the instant invention to provide a system for safe MPE disablement in which data pertaining to the monitoring and disablement of MPEs can be accessed and modified via an Internet web site.

It is a further objective of the instant invention to provide a system for safe MPE disablement which can be automatically actuated based on geographic or calendar parameters.

It is a still further objective of the invention to provide a system for safe MPE disablement which includes a global positioning system (GPS).

It is yet another objective of the instant invention to provide a system for safe MPE disablement using a communication means to link MPEs and a base station for bidirectional data transfer, where the communication means can be a cellular network, a pager system, RF transceivers, or a satellite network.

It is a further objective of the present invention to provide a system for safe MPE disablement in which geographic and calendar parameters can be transmitted to a processor resident in the MPE using a wireless communication means.

It is still a further objective of the present invention to provide a system for safe MPE disablement which utilizes wireless communication between an onboard CPU and smart relays which are operable to disable the vehicle.

In accordance with the above objectives, a MPE having an onboard vehicle processor (CPU) includes at least one component control unit (CCU) which is coupled to at least one critical component of the MPE. The component control unit is operable to disable the at least one critical component to effect immobilization of the MPE in a first mode of operation, and is operable to enable the at least one critical component in second mode of operation. The critical component can be enabled either subsequent to disablement or enabled from a default disabled state. The CCU is controlled by the CPU. The critical components are any power components essential to operation of the MPE such as the ignition system, the fuel injector, fuel pump, battery, starter solenoid, key power circuit, and the various electronic control modules (engine, transmission, hydraulics, etc.) The CCU can include an electro-mechanical relay or an electronic switch operable to open and/or close an electrical circuit to supply or interrupt power to the critical operation component. Using an integral communications interface, the CPU can be accessed by a cellular telephone network, pager signal, RF transmission, or via a satellite network.

A software algorithm resident on the CPU is provided which can initiate a Disable Procedure comprising the steps of:
querying the binary status of the key power circuit and/or the ignition system, wherein said step of querying the binary status of the key power circuit and/or the ignition system is repeated continuously at a pre-set interval if the ignition is on; and
disabling the at least one critical component if the key power circuit and/or
the ignition system is off for a predetermined interval by actuating the CCU

In a first embodiment of the invention, a method for controlled disablement of a MPE from a remote location comprises the steps of providing a host processor coupled to a communications means operable to transmit a wireless Disable Command to a MPE remotely located from the host processor. A communications unit is coupled to an onboard CPU which is operable to receive wireless Operational Commands and initiate either a Disable or Enable Procedure.

In a second embodiment of the invention, a method for confining a MPE to a prescribed geographic area by controlled automatic disablement of the MPE comprises providing a global positioning system (GPS) resident on the MPE and at least one CCU controlled by the CPU. The CCU is coupled to at least one critical component of the MPE. A geographic coordinate perimeter is defined which circumscribes a containment area for the MPE and the perimeter coordinates are stored in the CPU memory and/or the host processor. A software algorithm is operable to perform the steps of: retrieving real-time GPS coordinates for the physical location vehicle at pre-set intervals; comparing the real-time GPS coordinates with the defined perimeter coordinates to determine if the vehicle is within the containment area; and initiating the Disable Procedure if the vehicle is outside of the containment area.

A remote host processor can be provided which is in operative association with a bidirectional wireless communications unit, and a reciprocal bidirectional wireless communications unit can be provided onboard the MPE in operative association with the CPU. The realtime GPS coordinates for the vehicle can be transmitted to the host processor at a preset interval.

In a third embodiment of the invention, a method for establishing date and time dependent operation of a MPE by controlled automatic disablement of the vehicle comprises providing an onboard CPU having an integral date and time function calibrated to output Current Time and Date, programming the CPU to define Authorized Time and Date Intervals for use of the MPE, providing at least one CCU controlled by the CPU which is coupled to at least one critical component of the MPE. A software algorithm is provided which performs the steps of determining if concurrency exists between the Current Time and Date and the Authorized Time and Date Intervals and initiating the Disable Procedure if no concurrency exists.

The step of programming the on board CPU to define Authorized Time Intervals for use of the MPE can further comprise the steps of providing a host processor coupled to a wireless communications means operable to transmit data to the MPE remotely; and providing a communications unit onboard the MPE which is operable to receive data from the host processor, and transmitting Authorized Time Intervals from the host processor to the CPU whereby the Authorized Time Intervals are programmed into the CPU.

In another aspect of the invention, the step of programming the onboard CPU to define Authorized Time Intervals for use of the MPE can further comprise the steps of providing a communications unit coupled to the CPU operable to receive data via a cellular telephone network, and transmitting Authorized Time Intervals over a cellular telephone network to the CPU whereby the Authorized Time Intervals are programmed into the CPU.

In each of the above embodiments, the host processor can be coupled to an Internet or intranet server to permit communication with the host processor from a remote workstation via a web browser, thus allowing bidirectional data exchange between the remote workstation and the CPU. The CPU can also collect diagnostic data from the operation of the MPE which can be transmitted to the host processor and accessed via the Internet.

To detect tampering with the system, the CPU continuously monitors the positive or negative operational status of each of the CCUs. A software algorithm resident on the CPU continuously executes a Tamper Detection Procedure which queries the operational status of each of the plurality of CCUs. If at least one of the CCUs is un-responsive, the CPU initiates a Disable Procedure whereby at least one of the remaining CCUs is then actuated to immobilize the vehicle.

Other objects and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE FIGURES

FIG. 1 is a schematic illustration of the elements of a system for the remote enablement and disablement of a MPE according to a preferred embodiment of the invention.

FIG. 2 illustrates the steps of the Disable Procedure according to the preferred embodiment of the invention;

FIG. 3 illustrates the step by which a geographic containment system is implemented;

FIG. 4 illustrates the process by which the geographic containment alarms are initiated;

FIG. 5 illustrates the step by which Calendar dependent operation of the MPE is implemented; and

FIG. 6 schematically illustrates the elements of an Internet-based management system in a preferred embodiment of the invention.

### DETAILED DESCRIPTION OF THE INVENTION

Although the invention will be described in terms of a specific embodiment, it will be readily apparent to those skilled in this art that various modifications, rearrangements, and substitutions can be made without departing from the spirit of the invention. The scope of the invention is defined by the claims appended hereto.

The present invention provides an apparatus, system and method which provides a means for remote and/or automatic disabling of a motor vehicle, with particular applicability to Mobile Pieces of Equipment (MPEs). The MPE is also disabled in the event tampering is detected. The disabling function can be built into a original equipment manufacturer (OEM) components of the MPE, or can be added as an after market kit. The potential liability of disabling a vehicle while in operation, either on purpose or accidentally, is an undesirable aspect of any vehicle disabling system. The safe disablement of a mobile piece of equipment is a critical aspect of any system that involves disabling, and the instant invention provided an improved method of remote or automatic disablement of a vehicle.

The system of the invention as described herein is particularly applicable to the management of construction equipment and the like, referred to herein as “MPEs.” However, the invention is not limited in this regard, and can also be used with any type of motor vehicle, including, but not limited to, automobiles, semi-trucks, motorcycles, boats, personal watercraft, airplanes, recreational vehicles, helicopters, snowmobiles, utility vehicles, etc.

In the preferred embodiment of the invention, the MPE includes an onboard processor (CPU) having a memory and communication means. Upon receipt of a remote disable command, the processor continuously query binary key power circuit status of the vehicle to determine if it is on or off. The term “key power circuit” as used herein includes all ignition functions which are in a positive state when the engine of the MPE is engaged.

After receiving a disable command, a Disable Procedure is initiated if the querying process indicates the key power circuit is off. If the MPE key power circuit status is determined to be on, then the CPU will permit normal vehicle operation, but will commence a monitoring procedure of the key power circuit status on a pre-determined time interval. The time interval of the monitoring procedure is programmable to desired value. For example, the time interval could be taken in increments every 10 minutes or 10 seconds depending on the degree of security preferred. If the key power circuit status is determined to be in an “off” state for a predetermined interval, then the CPU communicates with one or more component control units (CCUs) which are attached or embedded to various components and which have means to disable vehicle operation. Once disabled, all re-key power circuit attempts to a vehicle are not permitted until a remote enable command is given to the CPU and in turn the respective CCUs are instructed to enable their respective components. For the safety of the operator, the MPE is disabled only after the key power circuit has been off for a predetermined interval of time, e.g. 60 seconds, so that the MPE can be restarted if it has inadvertently stalled in an unsafe situation.

For after market systems, CCUs with embedded electrical mechanical smart relays or electronic switches are attached to one or more critical operational components of the MPE. These could include, but which would not be limited to, the starter solenoid, the key power circuit, the fuel pump, fuel injector, and the vehicle battery. For an OEM system, the onboard CPU or engine control module is programmed during the manufacturing process to receive a remote disable command to disable one or more similar critical vehicle operational components which have integral smart relays or electronic switches to electromechanically or electronically interrupt power and functioning of the critical components.

Once a CCU has received a disable component command from the CPU, then it in turn has means to open or close its respective electro mechanical smart relay or electronic switch thereby interrupting the power to operate the components to which they are attached. This in turn prevents the MPE from re-ignition and operation. The monitoring and communication process onboard the MPE between the CPU and the CCUs can use the either the existing vehicles wiring harness or short range wireless frequencies. The remote communication to the CPU is can be over the public and military wireless networks and spectrums including, but not limited to, pager, cellular, RF transmissions or by satellite communications. In another aspect of the invention, the system provides a means for remotely managing the mobile vehicle from a private or public networks such as an organization's intranet or the public Internet. In this way, the system can be remotely managed using personal digital assistant units, mobile phones, as well as personal computers and laptops.

As disclosed herein, the present invention contemplates four embodiments, namely a remote MPE disabling system via a wireless communication means, a geographic boundary system with automatic disabling, a time/date based disablement mechanism, and a tamper detection disabling mechanism. Although these embodiments are presented separately herein for ease of description, the elements of the respective embodiments are freely interchangeable and combinable in accordance with the principles of the invention.

FIG. I schematically illustrates a system for remote disablement of a MPE. The MPE 10 includes a CPU 12 which includes a memory means coupled to a wireless communications unit 14. For an OEM installation, the CPU 12 can be incorporated into the vehicle's standard computer control module. The wireless communications unit 14 can receive wireless coded Disable Command from a remotely located source. At least one CCU 16 is coupled to at least one critical operational components of the MPE 10. The critical components can include the key power circuit, the starter solenoid, the fuel pump, fuel injector, the MPE battery and other electronic control modules in the MPE 10. The CCU 16 is actuatable by the CPU 12 and is operable in a first mode of operation to disable the at least one critical component to effect immobilization of the MPE 10. In a second mode of operation, the CCU 16 can enable the at least one critical component to render the MPE 10 operational. In operation, the CCU can be enabled either subsequent to disablement, or the CCU can be remotely enabled from a default disabled state to permit use of the MPE by an authorized operator.

The CCUs 16 can communicate with the CPU 12 using any suitable communications link in the MPE 10. The communications link can be either hard wiring or a wireless communications means. In the practice of the invention, the CCUs 16 can be the wireless electro-mechanical smart relays which are described in Applicant's copending U.S. patent application Ser. No. 10/621,235, the contents of which has been incorporated herein by reference. In this arrangement, the CPU 12 and the CCUs 16 can each include transmitters and receivers which can be RF, low frequency, infra-red, or a suitable combination thereof. The selection of wireless or hardwired communication links may be dependent on whether the system of the invention is used as an OEM installation or an after market installation. For a OEM installation, it may be preferable to incorporate hardwired communication links into the OEM wiring harness. In an after market installation, the use of wireless communication between the CPU 12 and the CCUs 16 would allow the CCUs to be discretely hidden within the MPE 10 without tell-tale wiring at locations unfamiliar to thieves

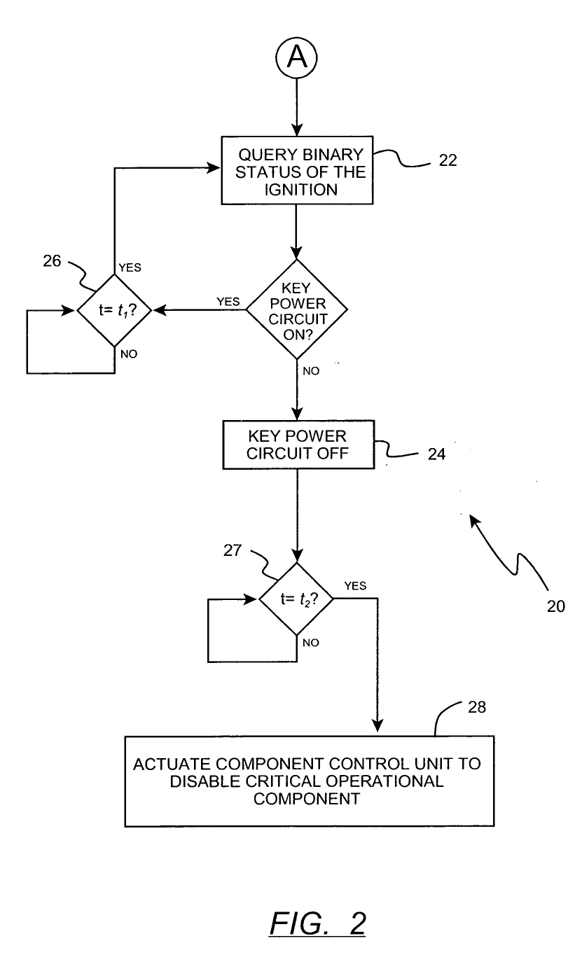

A software algorithm 20 as shown in FIG. 2 resides on the CPU 12 which initiates a Disable Procedure in response to a Disable Command received by the CPU 12. In step 22, the CPU 12 queries the binary status of the MPE key power circuit to determine if the key power circuit is on or off. If the key power circuit is off (step 24), and remains off for a pre-determined interval t₂ (step 27), the CCUs 16 are actuated to effect disablement of at least one critical component of the MPE to immobilize the MPE. If input is on, the step of querying the binary status of the key power circuit is repeated continuously at a pre-set time interval t₁ (step 26). When the query returns an “key power circuit off” indication (step 28) the at least one CCU 16 is actuated so that it disables the corresponding critical operational component.

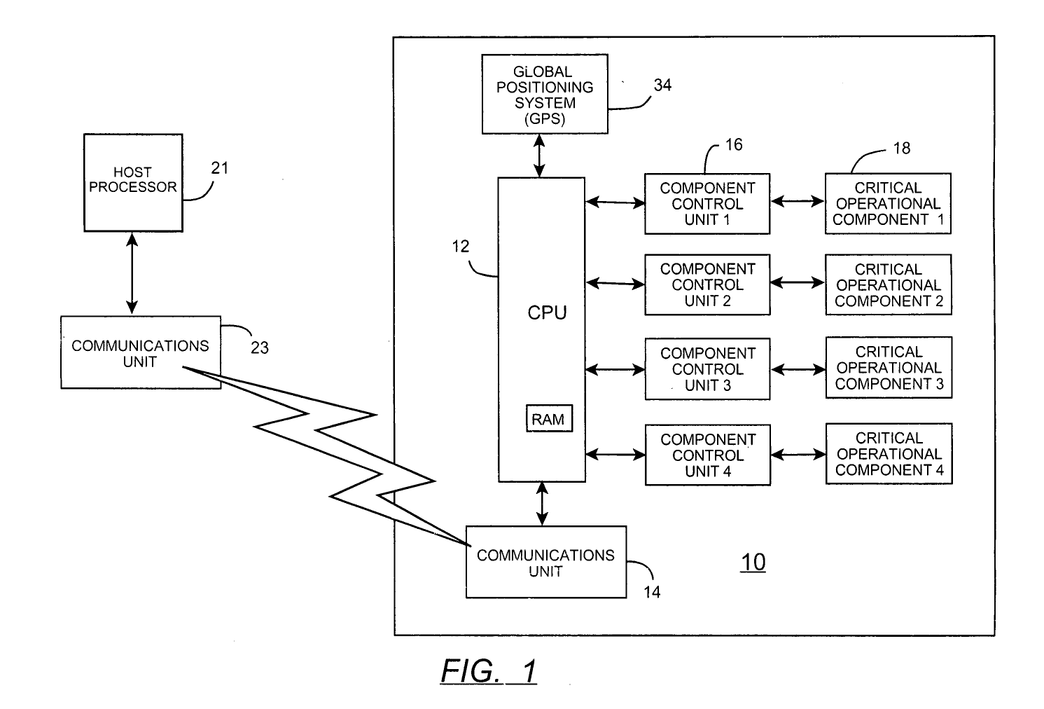

The communications unit 14 can be a pager unit, and the wireless Disable Command can be a pager signal which can be transmitted from any suitable source to provide a one-way transmission system. In a preferred embodiment, the communications unit 14 can be a wireless bidirectional communications device such as a cellular telephone, an RF transceiver, or other similar device. The Disable Command can originate from a reciprocal remotely located bidirectional communications unit. Referring again to FIG. 1, the system can include a host processor 21. coupled to a bidirectional communications unit 23 which enables the host processor 21 to be in communication with the CPU 12. The host processor 21 can initiate transmission of the Disable Command to the CPU 12. The CPU 12 in turn can initiate a transmission confirming that immobilization has been effected, and can also transmit other relevant information such as location coordinates from an onboard GPS system. The CPU 12 can also transmit diagnostic data from sensors in the MPE so that it can be maintained in a database on the host processor 21. The CPU 12 can also initiate visible and audible alarms in response to the Disable Command such as flashing lights and sounding the horn After the MPE is disabled, an Enable command can be sent from a remote source so that the MPE can be made operational.

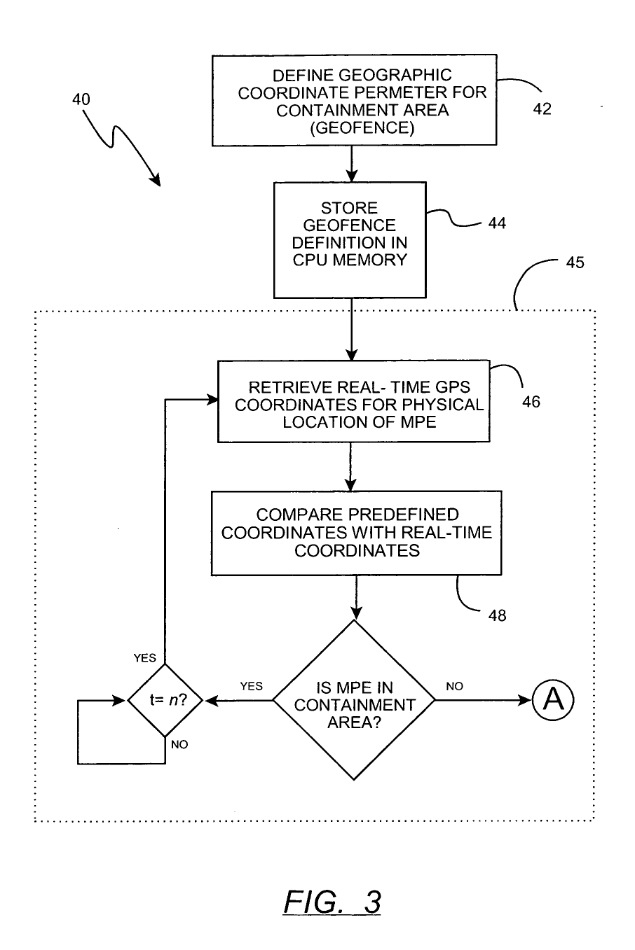

As shown in FIG. 1, the CPU 12 can receive data from a global positioning system (GPS) 34 resident in the MPE 10. FIG. 3 details the steps 40 by which a containment area or “geofence” is prescribed for operation of the MPE using the GPS unit in order to establish a means for automatic disablement of the MPE when the MPE leaves the containment area. In step 42, a geographic coordinate perimeter is defined which circumscribes a containment area for the MPE. The geographic coordinate perimeter is stored in the CPU memory (step 44). A software algorithm 45 is provided which is operable to perform the steps of: retrieving real-time GPS coordinates for the physical location of the MPE at pre-set intervals (step 46), comparing the real-time GPS coordinates with the defined coordinates perimeter to determine if the MPE is within the containment area (step 48); and initiating a Disable Procedure (FIG. 2) if the MPE is outside of the containment area.

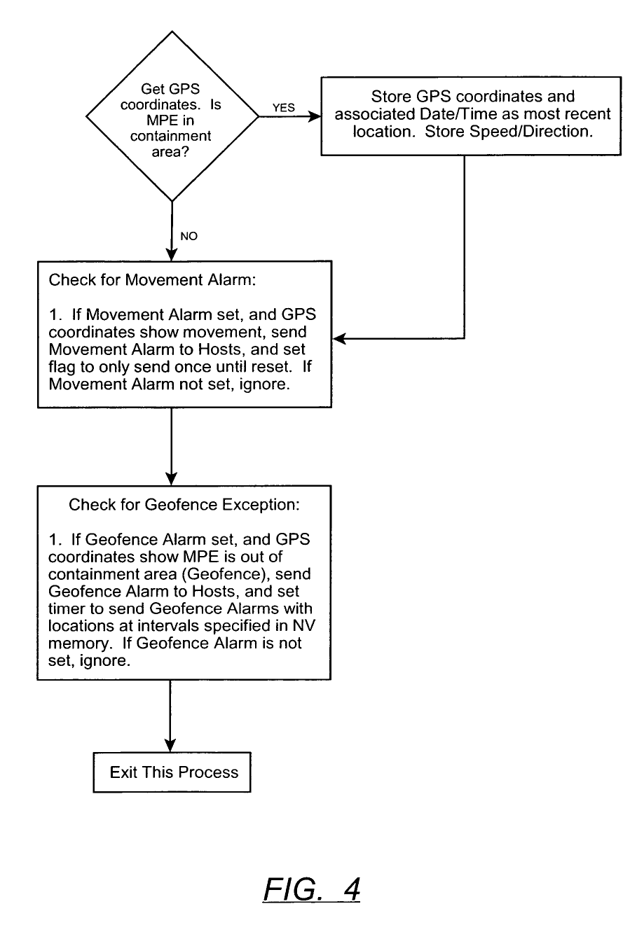

The CPU 12 can transmit real-time GPS coordinates from the MPE to the host processor 21. The coordinates of the containment area can be programmed on site into the CPU 12, or alternatively can be transmitted from the host processor 21 or other external source. The CPU 12 can also actuate the CCUs 16 in response to Movement Alarm generated by unauthorized movement of the MPE as determined by the GPS unit. FIG. 4 illustrates the process by which the Movement Alarms and Geofence alarms are initiated.

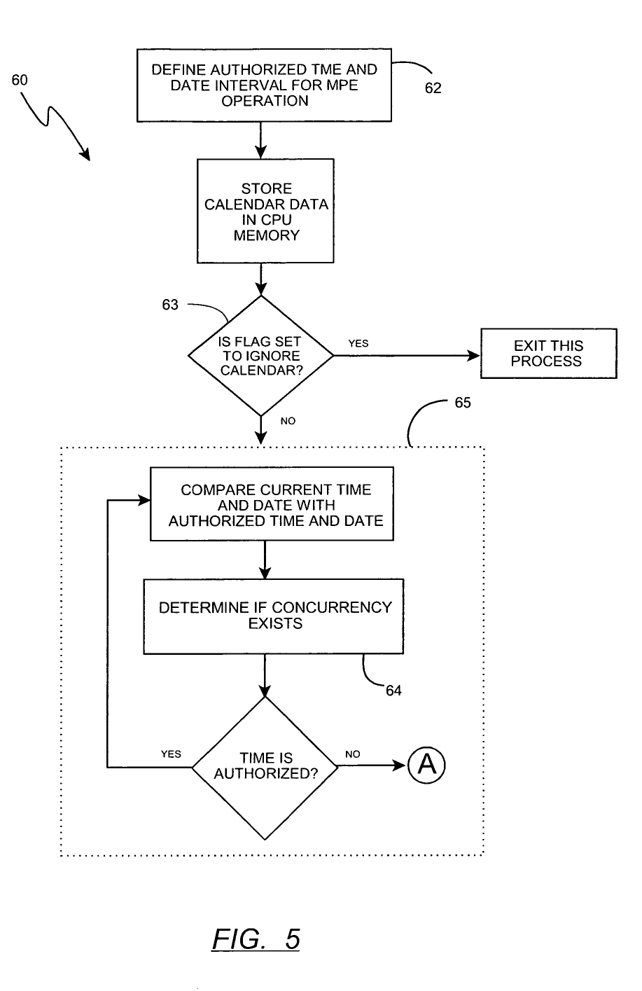

In a third embodiment of the invention, date and time dependent operation of a MPE is provided by controlled automatic disablement of the MPE when operation is attempted at unauthorized times. FIG. 5 illustrates the steps 60 of this process. The CPU 12 includes an integral date and time function calibrated to output Current Time and Date. The CPU 12 is programmed to define Authorized Time Intervals for use of the MPE (step 62). A software algorithm 65 resident on the CPU is operable to perform the steps of: determining if concurrency exists between the Current Time and Date and the Authorized Time Intervals (step 64). and initiating the Disable Procedure (FIG. 2) if no concurrency exists. The process further includes a master override procedure (step 63) which enables a flag to be set to ignore the calendar.

The step of programming the CPU 12 to define Authorized Time Intervals for use of the MPE further can be accomplished on site by directly accessing the CPU 12. The Authorized Time Intervals can also be transmitted to the CPU 12 from remote sources, such as the host processor 21 or via a direct connection using a hand held telephone or other communications device.

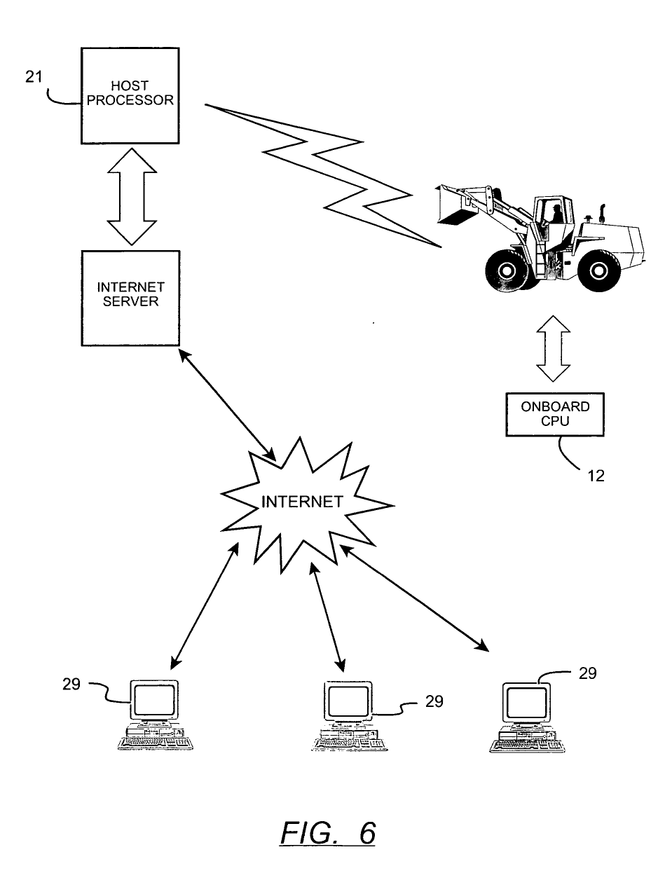

As shown in FIG. 6, the host processor 21 can be an Internet server, or alternatively can be coupled to an Internet server. Data on the host processor 21 can be accessed via the Internet from remote workstations 29, such as personal computers or PDA devices. A Disable Command can be initiated from the remote workstations 29, and the status of a MPE can be monitored by users at remote workstations via a web site interface. Other pertinent data can be transmitted through the Internet to the CPU 12 from remote workstations, such as the Authorized Time and Date intervals and coordinates for the GPS boundaries to be programmed into the CPU 12. Also, a disabled MPE can be made operational by sending an Enable command to the CCUs. The CPU 12 can continuously transmit data to the host processor 21, which can be available to users at the remote workstations 29. This data can include real-time GPS coordinates, operational status, and diagnostic data. The MPE can also be equipped with surveillance devices such as video and still image cameras and microphones. Digital images and sound recordings can be transmitted to the host processor 21 and made available on the web site to aid in law enforcement efforts.

The Disable Procedure can also be programmed to commence automatically if tampering with the CPU 12 or the CCUs 16 is detected. This can be implemented by programming the CPU 12 to query the operation of the CCUs 16 at pre-determined time intervals whereby any failure to receive a response from the CCUs 16 would initiate a Disable Procedure using the remaining active CCUs.

In the preferred embodiment, the CPU 12 continuously monitors the positive or negative operational status of each of the CCUs 16. A software algorithm resident on the CPU 12 continuously executes a Tamper Detection Procedure which queries the operational status of each of the plurality of CCUs and initiates a Disable Procedure if at least one of the CCUs is non-responsive. The Disable Procedure is implemented by actuating another CCU having positive operational status so that the corresponding critical operational component is disabled.

The system of the present invention contemplates an arrangement in which a fleet of MPEs are rendered disabled in a default state, and are then selectively enabled as required from a remote central location. In such a system, the Disable Procedure is effectively a “Cancel Enable” command which returns the MPE to its default, disabled condition. The present invention thus provides a very effective system for management and control of numerous MPEs.

It is to be understood that while a certain form of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

1. A method for controlled disablement of a mobile piece of equipment MPE from a remote location, comprising:
providing a host processor coupled to a communications means operable to transmit a wireless Operational Commands to a MPE remotely located from the host processor, wherein the Operational Commands include Enable and Disable Commands;
providing a communications unit onboard a MPE operable to receive the wireless operational commands, wherein said communications unit is coupled to a CPU onboard the MPE;
providing at least one component control unit (CCU) linked to the CPU by a communications means and actuatable by the CPU, wherein the CCU is coupled to at least one critical component of the MPE and is operable in a first mode of operation to disable the at least one critical component to effect immobilization of the MPE in response to a Disable Command and is operable in a second mode of operation to enable the at least one critical component in response to an Enable Command;
providing a software algorithm resident on the CPU which initiates a Disable Procedure in response to a Disable Command received by the CPU; wherein the Disable Procedure comprises the steps of:
querying the binary status of the MPE key power circuit, wherein
said step of querying the binary status of the key power circuit is repeated continuously at a pre-set interval if the key power circuit is on; and
disabling the at least one critical component if key power circuit is off for a pre-determined interval by actuating the CCU.

2. The method of claim 1, wherein the communications units coupled to the host processor and CPU are bidirectional wireless communications units.

3. The method of claim 2, wherein the bidirectional communications units are cellular telephone transceivers.

4. The method of claim 2, wherein the bidirectional wireless communications units are RF transceivers.

5. The method of claim 2, wherein the bidirectional wireless communications units are two-way paging transceivers.

6. The method of claim 2, wherein the bidirectional wireless communications units are satellite paging transceivers.

7. The method of claim 2, wherein the CPU collects diagnostic data from the operation of the MPE, and the diagnostic data is transmitted to the host processor.

8. The method of claim 1, wherein the CCU includes an electro-mechanical relay operable to selectively open and close an electrical circuit.

9. The method of claim 1, wherein the CCU includes a switch operable to selectively open and close an electrical circuit.

10. The method of claim 1, wherein the communications means linking the at least one CCU and the CPU is hard wiring.

11. The method of claim 1, wherein the communications means linking the at least one CCU and the CPU is wireless.

12. The method of claim 2, wherein the host processor is coupled to an Internet server and the host processor is in communication with a remote workstation via a web browser.

13. A method for confining a mobile piece of equipment (MPE) to a prescribed geographic area by controlled automatic disablement of the MPE, comprising:
providing a CPU having a memory onboard the MPE, wherein the CPU is in operative communication with a global positioning system (GPS) resident on the MPE;
providing at least one component control unit (CCU) linked to the CPU by a communications means and actuatable by the CPU, wherein the CCU is coupled to at least one critical component of the MPE and is operable to disable the at least one critical component to effect immobilization of the MPE;
defining a geographic coordinate perimeter wherein the perimeter circumscribes a containment area for the MPE;
providing a software algorithm operable to perform the steps of:
retrieving real-time GPS coordinates for the physical location MPE at pre-set intervals;
comparing the real-time GPS coordinates with the defined coordinates perimeter to determine if the MPE is within the containment area; and
initiating a Disable Procedure if the MPE is outside of the containment area, wherein said step of initiating a Disable Procedure comprises the steps of:
querying the binary status of the MPE's key power circuit, wherein said step of querying the binary status of the key power circuit is repeated continuously at a pre-set interval if the key power circuit is on; and
disabling the at least one critical component if key power circuit is off for a pre-determined interval by actuating the CCU.

14. The method of claim 13, wherein said step of defining a geographic coordinate perimeter further comprises the step of storing the geographic coordinate perimeter in the CPU memory.

15. The method of claim 13, further comprising the steps of:
providing a remote host processor having a memory in operative association with a bidirectional wireless communications unit; and
providing a reciprocal bidirectional wireless communications unit onboard the MPE in operative association with the central processor unit whereby the host processor is in communication with the central processor unit.

16. The method of claim 15, wherein said step of defining a geographic coordinate perimeter further comprises the step of storing the geographic coordinate perimeter in the host processor memory.

17. The method of claim 13, wherein the communications means linking the at least one CCU and the CPU is hard wiring.

18. The method of claim 13, wherein the communications means linking the at least one CCU and the CPU is wireless.

19. The method of claim 16, further comprising the step of transmitting the real time GPS coordinates for the MPE to the host processor at a preset interval.

20. The method of claim 15, wherein the bidirectional wireless communications units are cellular transceivers.

21. The method of claim 15, wherein the bidirectional wireless communications units are RF transceivers.

22. The method of claim 15, wherein the bidirectional wireless communications units are two way pager transceivers.

23. The method of claim 15, wherein the bidirectional wireless communications units are satellite transceivers.

24. The method of claim 13, wherein the CCU includes an electro-mechanical relay operable to selectively open and close an electrical circuit.

25. The method of claim 13, wherein the CCU includes a switch operable to selectively open and close an electrical circuit.

26. The method of claim l5, wherein the host processor is coupled to an Internet server and the host processor is in communication with a remote workstation via a web browser.

27. A method for establishing date and time dependent operation of a mobile piece of equipment (MPE) by controlled automatic enablement and disablement of the MPE, comprising:
providing an on board CPU having an integral date and time function calibrated to output Current Time and Date;
programming the CPU to define Authorized Time Intervals for use of the MPE;
providing at least one component control unit (CCU) linked to the CPU by a communications means and actuatable by the CPU, wherein the CCU is coupled to at least one critical component of the MPE and is operable in a first mode operation to disable the at least one critical component to effect immobilization of the MPE and in a second mode of operation to enable the at least one critical component;
providing a software algorithm resident on the CPU which is operable to perform the steps of:
determining if concurrency exists between the Current Time and Date and the Authorized Time Intervals;
initiating a Disable Procedure if no concurrency exists, wherein said step of initiating a Disable Procedure comprises the steps of:
querying the binary status of the MPE key power circuit, wherein said step of querying the binary status of the key power circuit is repeated continuously at a pre-set interval if the key power circuit is on; and
disabling the at least one critical component if key power circuit is off for a pre-determined interval by actuating the CCU.

28. The method of claim 27, wherein the communications means linking the at least one CCU and the CPU is hard wiring.

29. The method of claim 27, wherein the communications means linking the at least one CCU and the CPU is wireless.

30. The method of claim 27, wherein said step of programming the on board CPU to define Authorized Time Intervals for use of the MPE further comprises the steps of:
providing a host processor coupled to a wireless communications means operable to transmit data to the MPE remotely; and
providing a communications unit onboard the MPE operable to receive data from the host processor, wherein the communications unit is coupled to a central processor unit onboard the MPE; and
transmitting Authorized Time Intervals from the host processor to the CPU whereby the Authorized Time Intervals are programmed into the CPU.

31. The method of claim 27, wherein the host processor is coupled to an Internet server and is in communication with a remote workstation via a web browser, and further comprising the step of transmitting Authorized Time Intervals to the host processor from the remote workstation.

32. The method of claim 27, wherein said step of programming the CPU to define Authorized Time Intervals for use of the MPE further comprises the steps of:
providing a communications unit coupled to the CPU operable to receive data via a cellular telephone network; and
transmitting Authorized Time Intervals over a cellular telephone network to the CPU whereby the Authorized Time Intervals are programmed into the CPU.

33. The method of claim 27, wherein the CCU includes an electro-mechanical relay operable to selectively open and close an electrical circuit.

34. The method of claim 27, wherein the CCU includes a switch operable selectively open and close an electrical circuit.

35. A method for automatic disablement of a mobile piece of equipment (MPE), comprising:
providing a CPU onboard the MPE;
providing a plurality of component control units (CCUs) linked to the CPU by and actuatable by the CPU, wherein the plurality of CCUs are respectively coupled to a plurality of critical operational components of the MPE and are independently operable to disable the critical operational components to effect immobilization of the MPE;
providing a means whereby the CPU can monitor the positive or negative operational status of each of the CCUs;
providing a software algorithm resident on the CPU which continuously executes a Tamper Detection Procedure comprising the steps of:
querying the operational status of each of the plurality of CCUs; and
initiating a Disable Procedure if said step of querying the operational status at least one of the CCU is unresponsive status; wherein said step of initiating a Disable Procedure includes actuating at least one CCU having positive operational status whereby at least one critical component is disabled.

36. The method of claim 35, wherein the Disable Procedure further comprises the steps of:
querying the binary status of the MPE key power circuit, wherein said step of querying the binary status of the key power circuit is repeated continuously at a pre-set interval if the key power circuit is on; and
disabling the at least one critical component if key power circuit input is off for a pre-determined interval by actuating the CCU.
